(19) United States
(12) Patent Application Publication
(10) Pub. No.: US 2019/0114560 A1
(43) Pub. Date: Apr. 18, 2019

(54) REINFORCEMENT LEARNING SYSTEM FOR RECOMMENDED ASSOCIATIONS

(71) Applicant: CA, Inc., New York, NY (US)

(72) Inventors: Cui Lin, Sunnyvale, CA (US); Ye Chen, Milpitas, CA (US); Teodor J. Bally, San Jose, CA (US); Himanshu Pande, Sunnyvale, CA (US)

(21) Appl. No.: 15/783,563

(22) Filed: Oct. 13, 2017

(51) Int. Cl. G06N 99/00; G06N 5/04

(52) U.S. Cl. CPC G06N 99/005; G06N 5/046

(57) ABSTRACT

In various embodiments, a reinforcement learning system is disclosed that identifies recommended associations for users. The reinforcement learning system may store a dataset including preference information that indicates associations between items and the users. A recommended association between a particular user and one or more items may be requested. The reinforcement learning system may select a predicted preference identification algorithm for the particular user and may use the predicted preference identification algorithm to generate virtual preference information for the particular user. The virtual preference information may be included in a graph that indicates similarity values between various users of the dataset and the particular user. The reinforcement learning system may determine a recommended association based on the graph and may send the recommended association to the particular user. In some cases, feedback may be used to select a different predicted preference identification algorithm for the user.

### BACKGROUND

### Technical Field

This disclosure relates generally to a reinforcement learning system for recommended associations.

### Description of the Related Art

Databases may include information relating to a multitude of items in various contexts (e.g., relating to hobbies, education, entertainment, healthcare providers, etc.). Users may form associations with items by interacting with those items. Some associations may be preferred and other associations may not be preferred. However, due to the amount of items available in various contexts, users may not be able to consider all of the items in a timely manner to identify preferred associations. Recommended associations may be used to reduce the amount of items to be considered by the user.

### SUMMARY

In various embodiments, a reinforcement learning system for recommended associations is disclosed that identifies recommended associations for a particular user. The reinforcement learning system may store a dataset including preference information that indicates associations between items and users. Recommended associations between the particular user and one or more items of the dataset may be requested (e.g., by the particular user or automatically). The reinforcement learning system may select a predicted preference identification algorithm for the particular user from a plurality of algorithms. In some embodiments, the predicted preference identification algorithm may be selected based on a recommendation goal for the particular user, preference information of the particular user, features of the one or more items, or any combination thereof. In some cases, the preference identification algorithm may generate the recommended association directly.

In other embodiments, the reinforcement learning system may use the predicted preference identification algorithm to generate virtual preference information for the particular user. The virtual preference information may be included in a graph that indicates similarity values between various users of the dataset and the particular user. The reinforcement learning system may determine a recommended association based on the graph. Additionally, the reinforcement learning system may change the predicted preference identification algorithm for the particular user (e.g., for a second recommendation) in response to feedback regarding the recommended association. As a result of the feedback mechanism, the reinforcement learning system may, in some cases, automatically modify or adjust a recommendation process without human intervention.

In some cases, recommended associations generated by the reinforcement learning system may be more accurate, as compared to recommended associations generated by a system that does not include a plurality of predicted preference identification algorithms or does not change a predicted preference identification algorithm based on feedback. Additionally, recommended associations generated by the reinforcement learning system may be more accurate, as compared to recommended associations generated by a system that does not use the combination of the predicted preference identification algorithm and the graph-based algorithms. Further, in some embodiments, the reinforcement learning system using the combination of the predicted preference identification algorithm and the graph may reduce a number of items and associations considered when identifying the recommended associations. As a result, the reinforcement learning system may operate more quickly, may consume less power, or both, as compared to a system that does not use the combination of the predicted preference identification algorithm and the graph.

### BRIEF DESCRIPTION OF THE DRAWINGS

FIG. 1A is a block diagram illustrating a first embodiment of a recommended association process.

FIG. 1A is a block diagram illustrating a second embodiment of a recommended association process.

FIG. 2 is a block diagram illustrating a first example of a graph of one embodiment of a reinforcement learning system.

FIG. 3 is a block diagram illustrating a second example of a graph of one embodiment of a reinforcement learning system.

FIG. 4 is a block diagram illustrating interactions between various portions of one embodiment of a reinforcement learning system.

FIG. 5A is a flow diagram illustrating a first embodiment of a method of generating a recommended association.

FIG. 5B is a flow diagram illustrating a second embodiment of a method of generating a recommended association.

FIG. 6 is block diagram illustrating an embodiment of a computing system that includes at least a portion of a reinforcement learning system.

Although the embodiments disclosed herein are susceptible to various modifications and alternative forms, specific embodiments are shown by way of example in the drawings and are described herein in detail. It should be understood, however, that drawings and detailed description thereto are not intended to limit the scope of the claims to the particular forms disclosed. On the contrary, this application is intended to cover all modifications, equivalents and alternatives falling within the spirit and scope of the disclosure of the present application as defined by the appended claims.

This disclosure includes references to “one embodiment,” “a particular embodiment,” “some embodiments,” “various embodiments,” or “an embodiment.” The appearances of the phrases “in one embodiment,” “in a particular embodiment,” “in some embodiments,” “in various embodiments,” or “in an embodiment” do not necessarily refer to the same embodiment. Particular features, structures, or characteristics may be combined in any suitable manner consistent with this disclosure.

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical, such as an electronic circuit). More specifically, this formulation is used to indicate that this structure is arranged to perform the one or more tasks during operation. A structure can be said to be “configured to” perform some task even if the structure is not currently being operated. A “memory device configured to store data” is intended to cover, for example, an integrated circuit that has circuitry that performs this function during operation, even if the integrated circuit in question is not currently being used (e.g., a power supply is not connected to it). Thus, an entity described or recited as “configured to” perform some task refers to something physical, such as a device, circuit, memory storing program instructions executable to implement the task, etc. This phrase is not used herein to refer to something intangible.

The term “configured to” is not intended to mean “configurable to.” An unprogrammed FPGA, for example, would not be considered to be “configured to” perform some specific function, although it may be “configurable to” perform that function after programming.

Reciting in the appended claims that a structure is “configured to” perform one or more tasks is expressly intended not to invoke 35 U.S.C. § 112(f) for that claim element. Accordingly, none of the claims in this application as filed are intended to be interpreted as having means-plus-function elements. Should Applicant wish to invoke Section 112(f) during prosecution, it will recite claim elements using the “means for” [performing a function] construct.

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

As used herein, the phrase “in response to” describes one or more factors that trigger an effect. This phrase does not foreclose the possibility that additional factors may affect or otherwise trigger the effect. That is, an effect may be solely in response to those factors, or may be in response to the specified factors as well as other, unspecified factors. Consider the phrase “perform A in response to B.” This phrase specifies that B is a factor that triggers the performance of A. This phrase does not foreclose that performing A may also be in response to some other factor, such as C. This phrase is also intended to cover an embodiment in which A is performed solely in response to B.

As used herein, the terms “first,” “second,” etc. are used as labels for nouns that they precede, and do not imply any type of ordering (e.g., spatial, temporal, logical, etc.), unless stated otherwise. For example, in a computer system that includes six algorithms, the terms “first algorithm” and “second algorithm” can be used to refer to any two of the six algorithms, and not, for example, just logical algorithms zero and one.

When used in the claims, the term “or” is used as an inclusive or and not as an exclusive or. For example, the phrase “at least one of x, y, or z” means any one of x, y, and z, as well as any combination thereof (e.g., x and y, but not z).

In the following description, numerous specific details are set forth to provide a thorough understanding of the disclosed embodiments. One having ordinary skill in the art, however, should recognize that aspects of disclosed embodiments might be practiced without these specific details. In some instances, well-known circuits, structures, signals, computer program instruction, and techniques have not been shown in detail to avoid obscuring the disclosed embodiments.

### DETAILED DESCRIPTION

A reinforcement learning system for recommended associations is disclosed herein that generates recommended associations between users of a computer system and items indicated by a dataset. In some embodiments, a recommendation goal may be identified for a requested recommendation based on preference information of a requesting user (a particular user), characteristics of one or more of the items, or both. For example the reinforcement learning system may decide to recommend a movie in response to a request for a recommendation based on information about a requesting user (e.g., the user likes watching movies), information about the items (e.g., the items are all movies), or both. As discussed further herein, the one or more items are not intended to be limited to any particular context. The reinforcement learning system may select an algorithm from a plurality of algorithms as a predicted preference identification algorithm for the particular user. In some embodiments, the algorithm may be selected based on preference information of the particular user, the recommendation goal, or both. The algorithm may be used to determine a recommended association for the particular user. In response to the recommended association, the computer system may receive, indirectly or directly, feedback regarding the recommended association. In some cases, the predicted preference identification algorithm may be updated based on the feedback such that a future recommended association for the user may use a different predicted preference identification algorithm or a modified version of the previous predicted preference identification algorithm. Accordingly, the predicted preference identification algorithm may change over time (e.g., to more accurately identify predicted preferences for the user or as the user changes over time). In some cases, recommended associations generated by the reinforcement learning system may be more accurate, as compared to recommended associations generated by a system that does not include a plurality of predicted preference identification algorithms or does not change a predicted preference identification algorithm based on feedback.

In some embodiments, rather than generating a recommendation directly using the predicted preference identification algorithm, the reinforcement learning system may use the predicted preference identification algorithm in conjunction with a graph. In particular, the reinforcement learning system may generate virtual preference information for the particular user based on the predicted preference identification algorithm. The virtual preference information may be included in a graph that indicates similarity values between a plurality of users of the dataset. A recommended association may be determined based on the graph by identifying similar users and selecting the recommended association from the associations of the similar users. In some embodiments, feedback regarding the recommended association may be received. In some cases, the predicted preference identification algorithm may be updated based on the feedback such that a future recommended association for the user may use a different predicted preference identification algorithm or a modified version of the previous predicted preference identification algorithm. Accordingly, the predicted preference identification algorithm may change over time (e.g., to more accurately identify predicted preferences for the user or as the user changes over time). In some cases, the users of the graph may be a subset of the users of the dataset (e.g., selected based on corresponding predicted preference identification algorithms). Accordingly, in some cases, the reinforcement learning system may consider fewer users when generating the recommended association, as compared to a system where a predicted preference identification algorithm is not used. Further, in some cases, because both the predicted preference identification algorithm and the graph are used, a recommended association may be more accurate, as compared to recommended associations generated by a system that does not include a predicted preference identification algorithm, a graph, or both.

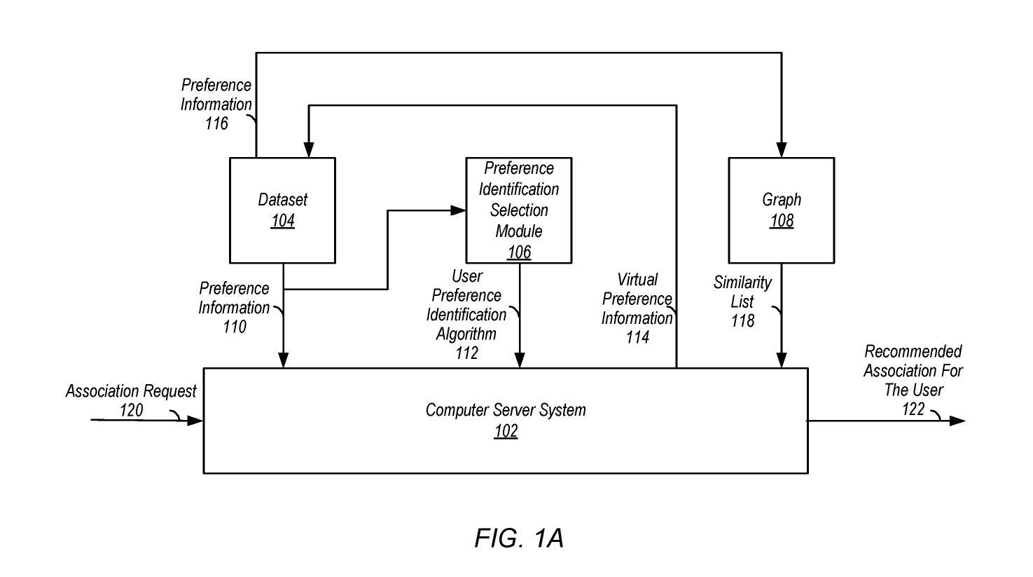

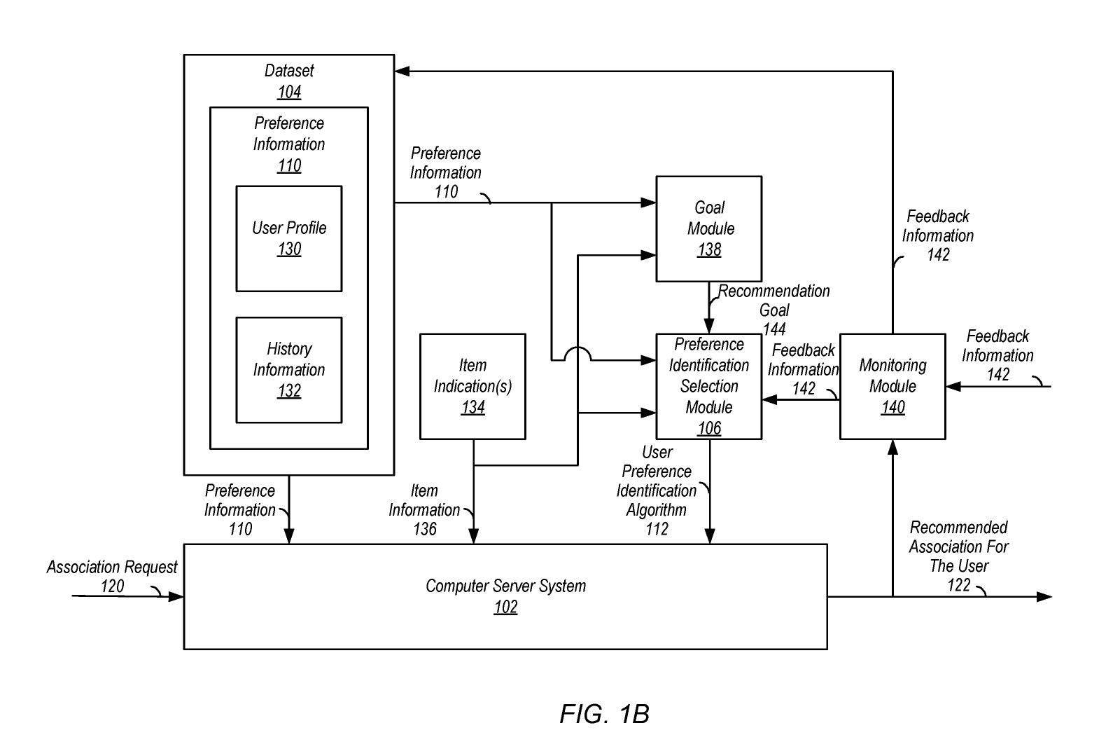

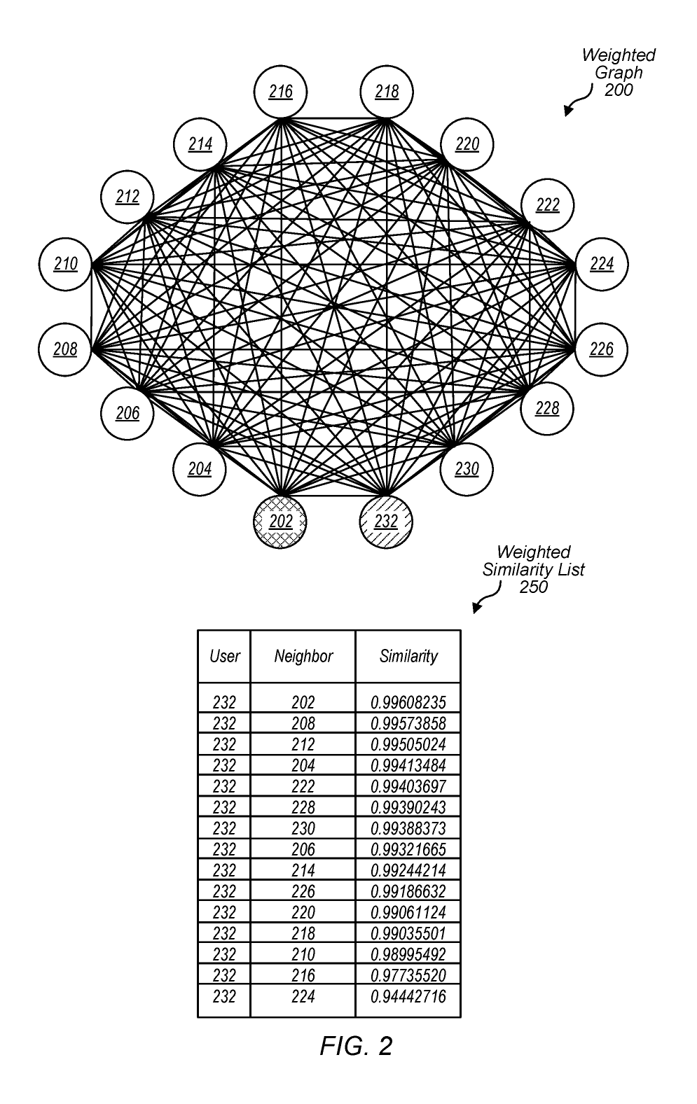

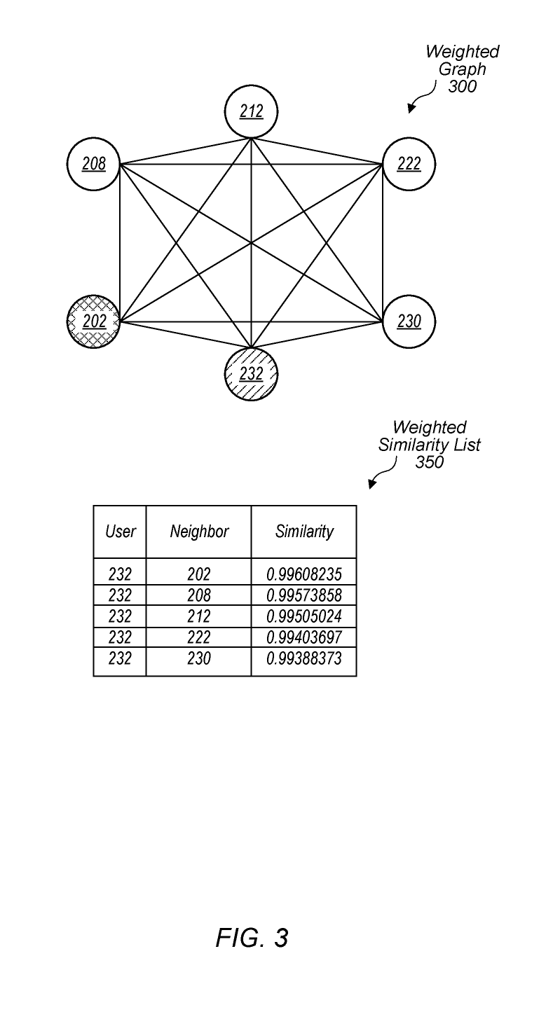

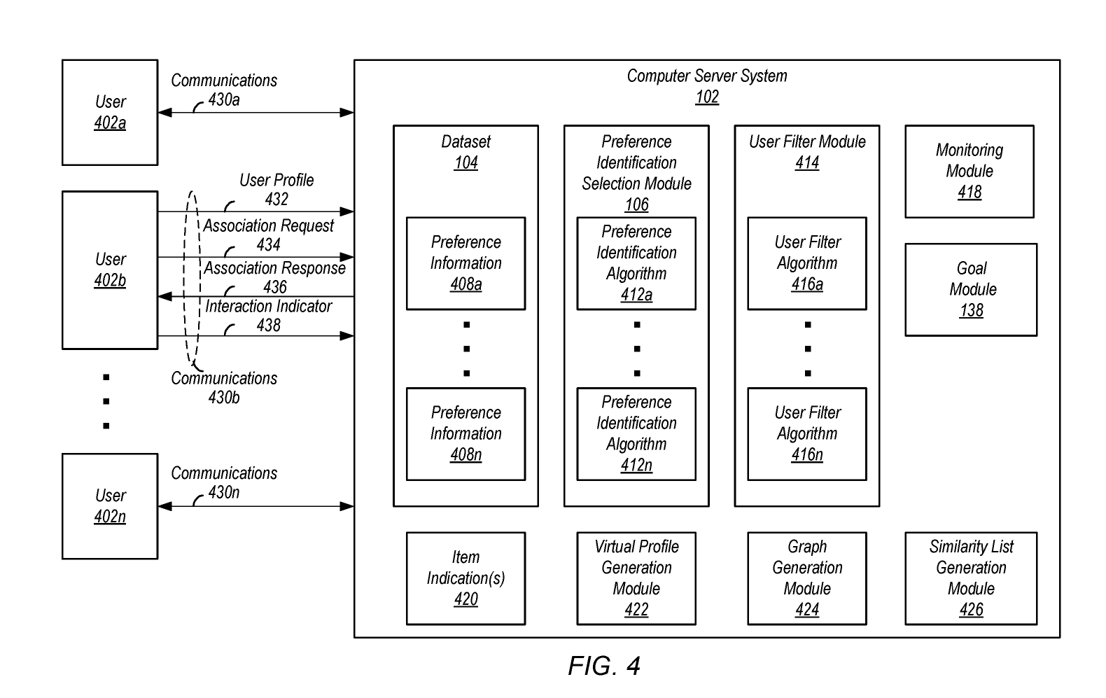

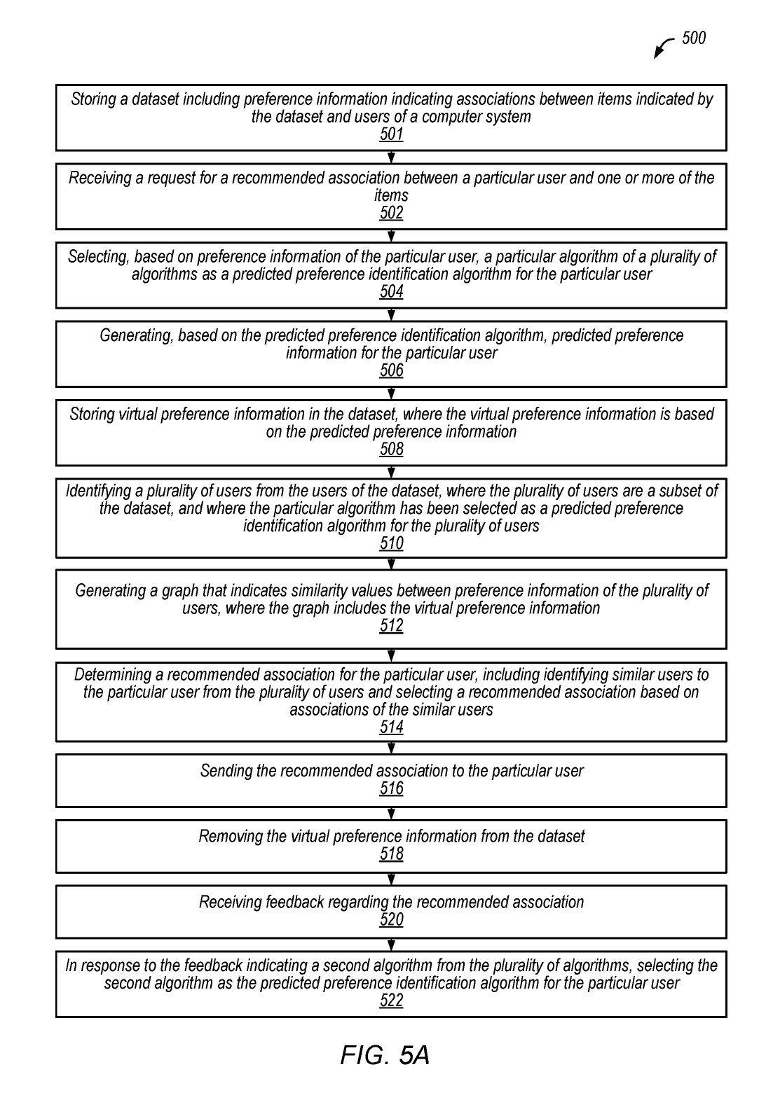

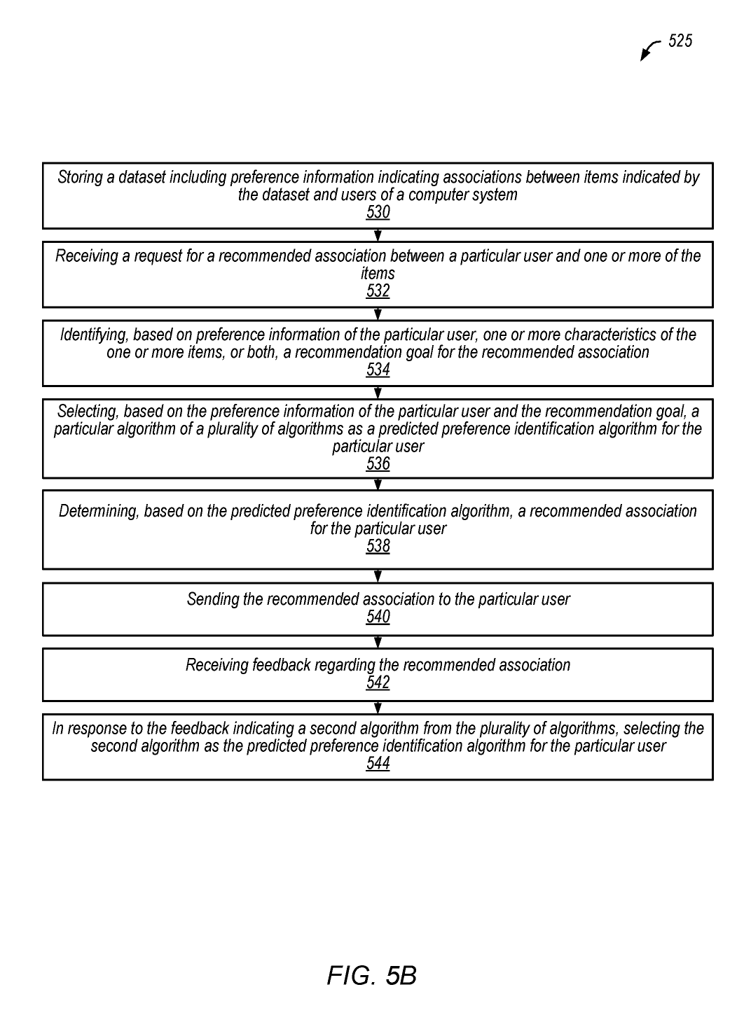

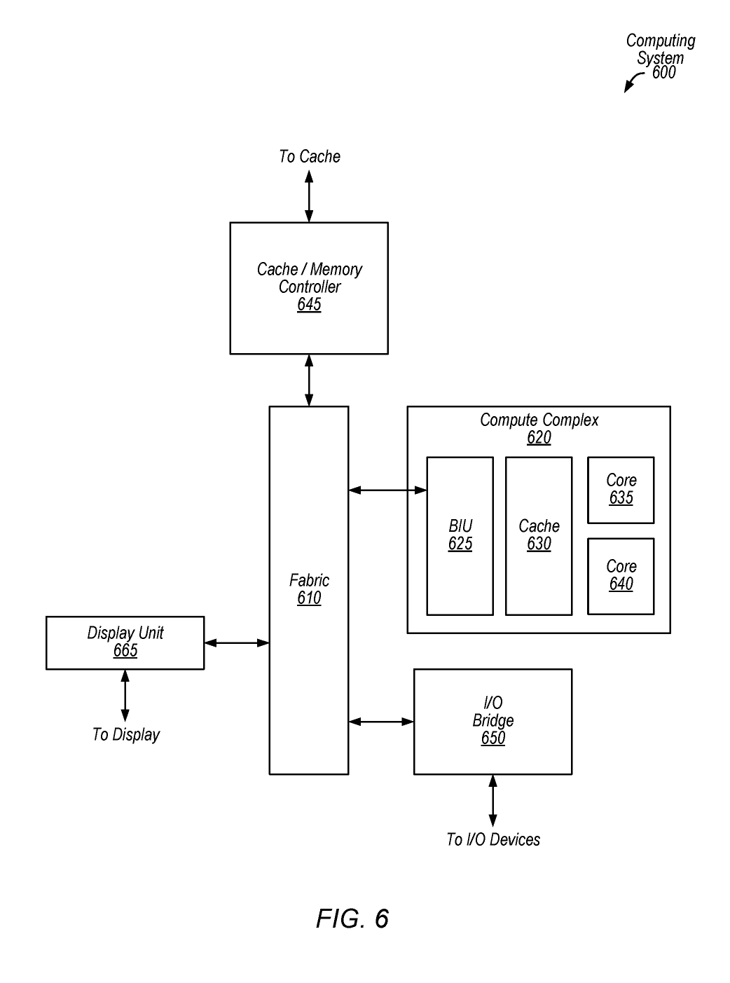

This disclosure initially describes, with reference to FIGS. 1A and 1B, various embodiments of a recommended association process. Exemplary graphs are described with reference to FIGS. 2-3. Portions of an exemplary reinforcement learning system are described with reference to FIG. 4. Various embodiments of a method of generating a recommended association is described with reference to FIGS. 5A and 5B. Finally, an embodiment of a computing system that includes a reinforcement learning system is described with reference to FIG. 6.

Turning now to FIG. 1A, a simplified block diagram illustrating a first exemplary recommended association process is shown. In the illustrated embodiment, the system includes computer server system 102, dataset 104, preference identification selection module 106, and graph 108. As further described below with reference to FIG. 4, in various embodiments, various portions of the recommended system may be combined into a single device or may be separated into various devices. For example, in some embodiments, computer server system 102 may include at least one of dataset 104, preference identification selection module 106, or graph 108.

Computer server system 102 may generate a recommended association for a user 122 in response to an association request 120, requesting a recommended association for the user 122. In some embodiments, association request 120 may be received from a user. In other embodiments, association request 120 may be received from another source (e.g., may be automatically generated by computer server system 102). Recommended association for the user 122 may recommend that the user interact with an item corresponding to at least a portion of dataset 104. As noted above, the term “item” is intended to be interpreted broadly. For example, recommended association for the user 122 may indicate that the user visit a particular healthcare provider, enroll in a particular educational system, take up a particular hobby, consider purchasing a particular real estate listing, or watch a particular movie.

In response to association request 120, computer server system 102 may receive preference information 110 of the user from dataset 104. Preference information 110 may include or indicate various associations between the user and items of dataset 104. In some embodiments, preference information 110 may include a user profile based on information provided by the user, default information, or both. Additionally, in some embodiments, preference information 110 may include history information for the user (e.g., information indicating feedback of the user or monitoring information for the user) in response to previous recommended associations. Additionally, computer server system 102 may receive user preference identification algorithm 112 for the user from preference identification selection module 106. In some embodiments, user preference identification algorithm 112 may be selected based on one or more portions of preference information 110, based on one or more features of one or more corresponding items, or both. Accordingly, in some cases, dataset 104 may send preference information 110 to preference identification selection module 106. Further, as further discussed below with reference to FIG. 1B, in some cases, user preference identification algorithm 112 may be selected based on a recommendation goal (e.g., a type of recommended item). Accordingly, different user preference identification algorithms may be selected for the user based on different recommendation goal (e.g., recommending a movie vs. recommending a healthcare provider). As discussed below with reference to FIG. 4, user preference identification algorithm 112 may differ from a user preference identification algorithm for a different user.

Based on user preference identification algorithm 112, computer server system 102 may generate virtual preference information 114 for the user. Virtual preference information 114 may indicate associations between the user and various portions of dataset 104, where at least some of the associations are not indicated by preference information 110. Computer server system 102 may store virtual preference information 114 in dataset 104 as preference information.

Graph 108 may be generated based on preference information 116 for a plurality of users from dataset 104, including virtual preference information 114. In various embodiments, preference information 116 may be a subset of the preference information stored at dataset 104. In some embodiments, as discussed below with reference to FIGS. 2-4, preference information 116 may be selected (e.g., filtered) by comparing corresponding user preference identification algorithms with user preference identification algorithm 112 (the user preference identification algorithm of the user). In some embodiments, preference information 116 may be selected by comparing items of dataset 104 associated with the respective users, by comparing preference information of the respective users, or both. Graph 108 may indicate similarities between the users of graph 108 (e.g., preference information 116, including preference information 110). In some embodiments, graph 108 may be a weighted graph. In some embodiments, graph 108 may be stored (e.g., at a memory device including dataset 104) and may be updated with virtual preference information 114. In other embodiments, graph 108 may be generated in response to association request 120. Graph 108 may be used to generate similarity list 118. Similarity list 118 may indicate similarities between preference information 110 and the other preference information of preference information 116, including virtual preference information 114. Computer server system 102 may output at least one of the associations as recommended association for the user 122. Because user preference identification algorithm 112 is used in combination with graph 108, in some cases, recommended association for the user may be more likely to be accepted by the user, as compared to a recommended association generated by a system that does not use a user preference identification algorithm and a graph. In embodiments where a subset of dataset 104 is used to generate graph 108, similarity list 118 may be generated more quickly, using less power, or both, as compared to a similarity list generated using all of the preference information of dataset 104.

As further discussed below with respect to FIG. 4, in various embodiments, feedback in response to recommended association for the user 122 may be used to update the process of FIG. 1A. For example, in response to the feedback, a different user preference identification algorithm may be selected (e.g., because preference information 110 is different).

Turning now to FIG. 1B, a simplified block diagram illustrating a second exemplary recommended association process is shown. In the illustrated embodiment, the system includes many of the devices described with reference to FIG. 1A, including computer server system 102, dataset 104, and preference identification selection module 106. Additionally, FIG. 1B includes item indications 134, goal module 138, and monitoring module 140. Further, preference information 110 includes user profile 130 and history information 132. FIGS. 1A and 1B are shown separately for clarity, but, in some embodiments, various portions may be combined. For example, in some embodiments, the system of FIG. 1A may include item indication(s) 134, goal module 138, monitoring module 140, or any combination thereof. Similarly, in some embodiments, the system of FIG. 1B may include graph 108. As further described below with reference to FIG. 4, in various embodiments, various portions of the recommended system may be combined into a single device or may be separated into various devices. For example, in some embodiments, computer server system 102 may include at least one of dataset 104, preference identification selection module 106, or graph 108.

Similar to the system of FIG. 1A, computer server system 102 may generate a recommended association for a user 122 in response to an association request 120, requesting a recommended association for the user 122. In some embodiments, association request 120 may include a requested type of recommended association, indicating a subset of items for the recommended association (e.g., entertainment options). In the illustrated embodiment, computer server system 102 generates the recommended association for the user 122 based on preference information 110 of the user, item information 136, and user preference identification algorithm 112. In particular, computer server system 102 may receive preference information 110 for the user from dataset 104. In some cases, preference information 110 may include user profile 130, history information 132, or both. As discussed further below with reference to FIG. 4, user profile 130 may include or indicate various associations between the users and items of item indications 134. User profile 130 may be based on various sources of information such as a user profile provided by the user. In some cases, user profile 130 may include default information about the user (e.g., because no corresponding information has been received for the user). History information 132 may include various information collected about the user in response to previous recommended associations. Item information 136 may include information about the items being considered for recommended association for the user 122. Computer server system 102 may use user preference identification algorithm 112 to generate recommended association for the user 122.

In the illustrated embodiment, preference information 110 and item information 136 are provided to goal module 138 (e.g., directly or indirectly, such as via computer server system 102). Goal module 138 may generate recommendation goal 144, which may identify a subset of the items of item indication(s) 134 as potential items to be identified by recommended association for the user 122 (potential recommended association targets). Recommendation goal 144 may be based on information from the user, preference information 110, item information 136 (e.g., features of the items of item indication(s) 134), or any combination thereof. For example, in response to association request 120 requesting entertainment options (a requested recommendation goal), goal module 138 may determine that item information 136 includes information about movies and information about nightclubs in the user's area as potential entertainment options. Based on features of preference information 110, goal module may determine that the user is more likely to accept a recommended association of a movie. Accordingly, recommendation goal 144 may indicate movies. In various embodiments, goal module 138 may generate recommendation goal 144 based on additional information or less information (e.g., without item information 136). As a result, of recommendation goal 144, the selected preference identification algorithm may be more accurate, may take less processor time to identify, may take less energy to identify, or any combination thereof.

In various embodiments, preference identification selection module 106 may include indications of a plurality of algorithms that could be used to generate recommended association for the user 122. Preference identification selection module 106 may identify user preference identification algorithm 112 from the plurality of algorithms based on preference information 110, item information 136, recommendation goal 144, or any combination thereof. For example, preference identification selection module 106 may identify a subset of the plurality of algorithms based on recommendation goal 144. One or more features of preference information 110, item information 136 (e.g., features common to a subset of items indicated by recommendation goal 144), or both, may be used to further narrow the algorithms until user preference identification algorithm 112 is identified. For example, in some cases, some algorithms may not be selected based on the user lacking a particular piece of preference information (e.g., because the user is a new user). The plurality of algorithms may include one or more of a matrix factorization algorithm, a naïve bays collaborative filtering algorithm, a user-based nearest neighbor regression algorithm, an item-based nearest neighbor regression algorithm, or a graph algorithm. In some embodiments, as discussed above, preference identification selection module 106 may select user preference identification algorithm 112 based on preference information of users similar to the user. In some cases, preference identification selection module 106 may have an open setup such that additional algorithms may be added. As discussed below with reference to FIG. 4, user preference identification algorithm 112 may differ from a user preference identification algorithm for a different user. Additionally, user preference identification algorithm 112 may differ from recommended association to recommended association for a single user based on different recommendation goals, based on item indication(s) 134 being updated, based on preference information 110 (e.g., history information 132) being updated, or any combination thereof.

As discussed above, computer server system 102 may generate recommended association for the user 122 based on preference information 110, item information 136, user preference identification algorithm 112, or any combination thereof. In some embodiments, monitoring module 140 may receive recommended association for the user 122. Additionally, monitoring module 140 may receive feedback information 142 regarding whether the user accepted the recommended association. Feedback information 142 may be direct (e.g., from a user survey) or indirect (e.g., monitoring whether the user accessed a recommended item). Monitoring module 140 may send feedback information 142 to dataset 104, where feedback information 142 may be used to update history information 132. As discussed above, as a result of changes to history information 132, a different user preference identification algorithm 112 may be selected for the user. Additionally, in some embodiments, feedback information 142 may be used to change a user preference identification algorithm for other users (e.g., users similar to the user). In some embodiments, monitoring module 140 may send feedback information 142 to preference identification selection module 106. In some cases, preference identification selection module 106 may use feedback information 142 in real-time to adjust user preference identification algorithm 112 or to select a different user preference identification algorithm for the user (e.g., for a future request).

Turning now to FIG. 2, an exemplary weighted graph 200 and corresponding weighted similarity list 250 are shown. Weighted graph 200 includes preference information 232 for a user corresponding to the recommended association, virtual preference information 202, and preference information 204, 206, 208, 210, 212, 214, 216, 218, 220, 222, 224, 226, 228, and 230 for corresponding users. In some embodiments, preference information 232 may correspond to preference information 110 and virtual preference information 202 may correspond to virtual preference information 114.

In the illustrated embodiment, weighted graph 200 may indicate similarities between preference information 202-232. As discussed above, in various embodiments, weighted graph 200 may be stored and updated as preference information (e.g. preference information 204) is added, removed, or modified. Accordingly, in some embodiments, in response to an association request, weighted graph 200 may be updated with virtual preference information 202. Subsequently, weighted graph 200 may be used to generate weighted similarity list 250 (e.g., by a computer server system such as computer server system 102). Weighted similarity list 250 may indicate similarities between preference information 232 and preference information 202-230. As discussed above, in some embodiments, the similarities of weighted similarity list 250 may be used in combination with associations corresponding to preference information 202-230 to identify one or more recommended associations (e.g., a weighted list of recommended associations).

Turning now to FIG. 3, an exemplary weighted graph 300 and corresponding weighted similarity list 350 are shown. Weighted graph 300 includes preference information 232 for a user corresponding to the recommended association, virtual preference information 202, and preference information 208, 212, 222, and 230 for corresponding users. In some embodiments, weighted graph 300 may correspond to a filtered version of weighted graph 200 of FIG. 2. For example, users corresponding to preference information 208, 212, 222, and 230 may all correspond to a same user preference identification algorithm as preference information 232 (e.g., for a same recommendation goal). Similarly, weighted similarity list 350 may correspond to a filtered version of weighted similarity list 250 of FIG. 2. In some embodiments, weighted graph 300 may be generated more quickly, using less power, or both, as compared to weighted graph 200. Similarity, weighted similarity list 350 may be generated more quickly, using less power, or both, as compared to weighted similarity list 250.

Turning now to FIG. 4, a simplified block diagram illustrating at least a portion of one embodiment of an exemplary reinforcement learning system for recommended associations is shown. In the illustrated embodiment, the reinforcement learning system includes computer server system 102. Further, users 402a-n are shown. In the illustrated embodiment, computer server system 102 includes dataset 104, preference identification selection module 106, user filter module 414, item indication(s) 420, virtual profile generation module 422, graph generation module 424, similarity list generation module 426, monitoring module 418, and goal module 138. In some embodiments, computer server system 102 may function as discussed above with reference to FIGS. 1A and 1B. As discussed above with reference to FIGS. 1A and 1B, in various embodiments, various portions of computer server system 102 may be combined or may be separate. For example, in some embodiments, dataset 104 may be separate from computer server system 102. As another example, in some embodiments, item indication(s) 420 may be stored in dataset 104. As another example, in some embodiments, graph generation module 424 may be combined with similarity list generation module 426. In some embodiments, one or more portions of computer server system 102 may not be present (e.g., virtual profile generation module 422, user filter module 414, graph generation module 424, monitoring module 418, goal module 138, or similarity list generation module 426). Additionally, as discussed above, in some embodiments, one or more portions of computer server system 102 may be separate.

In various embodiments, dataset 104 may include preference information 408a-n. Preference information 408a-n may indicate various user preferences of respective users 402a-n. In some embodiments, preference information 408a-n may include user profiles, history information, or both corresponding to respective users 402a-n. One of preference information 408a-n may correspond to preference information 110 of FIG. 1A, 1B, or both. In some embodiments, preference information 408a-n may include or correspond to information provided by users 402a-n (e.g., user profile 432). In some embodiments, preference information 408a-n may include or correspond to default information (e.g., because no preference information was provided). In some cases, preference information 408a-n may be updated based on associations corresponding to respective users 408a-n.

Item indication(s) 420 may indicate various items. For example, item indication(s) 420 may include items (e.g., electronic content), may refer to items (e.g., health provider listings), or both. As discussed above, in various embodiments, computer server system 102 may determine associations between users 402a-n and various items indicated by item indication(s) 420.

In various embodiments, preference identification selection module 106 may include preference identification algorithms 412a-n. Based on preference information (e.g., preference information 408a) preference identification algorithms 412a-n may generate various predicted associations between the corresponding user (e.g., user 402a) and various items (e.g., of item indication(s) 420). Preference identification selection module 106 may identify a particular preference identification algorithm for a user based on preference information of the user. Further, preference identification selection module 106 may identify a different particular preference identification algorithm for the user based on feedback (e.g., based on interaction indicators such as interaction indicator 438) regarding one or more recommended associations. In some embodiments, preference identification algorithms 412a-n may be machine learning algorithms. In some embodiments, recommended associations may be generated by the preference identification algorithms. In various embodiments, the preference identification algorithms may include a matrix factorization algorithm, a naïve bays collaborative filtering algorithm, a user-based nearest neighbor regression algorithm, an item-based nearest neighbor regression algorithm, a graph algorithm, another preference identification algorithm, or any combination thereof. In some embodiments, recommended associations may be generated based on a combination of one or more preference identification algorithms and a graph. In some cases, preference identification selection module 106 may have an open setup such that additional algorithms may be added.

As discussed above goal module 138 may identify a recommendation goal based on one or more of preference information for the user, item indications 420, or a requested association type. The recommendation goal may indicate a subset of preference identification algorithms 412a-n. As a result, the selected preference identification algorithm may be more accurate, may take less processor time to identify, may take less energy to identify, or any combination thereof.

Virtual profile generation module 422 may generate, based on preference information of a user (e.g., preference information 408n) and a corresponding preference identification algorithm (e.g., preference identification algorithm 412a), a virtual profile for the user. The virtual profile may include predicted preference information of the user generated based on the corresponding preference identification algorithm. As discussed above with reference to FIG. 1A, the virtual profile may indicate various associations between the user and items of item indication(s) 420. The virtual profile may be stored in dataset 104 and subsequently removed after a corresponding graph is generated. Different associations may be identified by virtual profiles generated based on a same set of preference information but based on different preference identification algorithms.

In the illustrated embodiment, a subset of users corresponding to dataset 104 may be included in a graph. In other embodiments, all users corresponding to dataset 104 may be included in the subset. User filter module 414 may identify users to include in the graph. In the illustrated embodiment, user filter module 414 includes a plurality of user filter algorithms 416a-n. User filter algorithms 416a-n may correspond to users and may identify the subset of users for graphs for the corresponding users. In various embodiments, user filter algorithms 416a-n may be selected based on at least one of preference information for the user, one or more interaction indicators (e.g., feedback from a user), or one or more other factors. For example, in some embodiments, a user filter algorithm for a user may be changed based on one or more interaction indicators for the user.

Graph generation module 424 may generate a graph based on preference information of dataset 104, as discussed above with reference to FIGS. 2 and 3. Similarity list generation module 426 may generate a similarity list based on a corresponding graph, as discussed above.

Monitoring module 418 may track feedback from a user regarding recommended associations. The feedback may be indirect or direct. For example, in some cases, monitoring module 418 may indirectly gather feedback by monitoring one or more actions of a corresponding user to gather feedback from the user. To illustrate, if a movie has been recommended to the user, monitoring module 418 may track whether the user accessed the movie. Additionally, in some cases, monitoring module 418 may track an amount of time that the user accessed the movie. Accordingly, monitoring module 418 may determine that the user did not like the recommended movie based on the user closing the movie after 20 minutes and failing to resume the movie. Additionally, in some cases, monitoring module 418 may receive feedback from the user directly. In various embodiments, the feedback may be used to alter a selection process of preference identification algorithms 412a-n for the user, user filter algorithms 416a-n for the user, or both.

In the illustrated embodiment, users 402a-n may communicate with computer server system 102 via communications 430a-n. In the illustrated embodiment, communications 430b include association request 434, association response 436, and interaction indicator 438. In some embodiments, communications 430b further include user profile 432. User profile 432 may indicate various associations between user 402b and items included in item indication(s) 420. User profile 432 may be included in corresponding preference information (e.g., preference information 408b) in dataset 104. Association request 434 may request a recommended association between user 402b and one or more items indicated by item indication(s) 420. In some embodiments, association request 434 may request a particular association type (e.g., may indicate a particular subset of items). As discussed above, in some embodiments, association request 434 may not be sent by user 402b. For example, association request 434 may be automatically generated by computer server system 102. In some embodiments, association request 434 may correspond to association request 120. Association response 436 may indicate one or more recommended associations. In some embodiments, association response 436 may correspond to recommended association for the user 122. Interaction indicator 438 may indicate feedback regarding the recommended association. As discussed above, interaction indicator 438 may be direct feedback from the user (e.g., a message from user 402b) or may be indirect feedback (e.g., an indication of whether user 402b accessed the recommended item).

Referring now to FIG. 5A, a flow diagram of a first method 500 of generating a recommended association is depicted. In some embodiments, method 500 may be initiated or performed by one or more processors in response to one or more instructions stored by a computer-readable storage medium. In various embodiments, some portions of method 500 may be performed in other orders. For example, in some embodiments, 518 may be performed before 516.

At 501, method 500 includes storing a dataset including preference information indication associations between items indicated by the dataset and users of a computer system. For example, computer server system 102 of FIG. 4 may store preference information 408a-n and item indications 420.

At 502, method 500 includes receiving a request for a recommended association between a particular user and one or more of the items. For example, computer server system 102 of FIG. 4 may receive association request 434 from user 402b, requesting a recommended association between user 402b and one or more items indicated by item indication(s) 420.

At 504, method 500 includes selecting, based on preference information of the particular user, a particular algorithm of a plurality of algorithms as a predicted preference identification algorithm for the particular user. For example, preference identification selection module 106 may select preference identification algorithm 412a for user 402b.

At 506, method 500 includes generating, based on the predicted preference identification algorithm, predicted preference information for the particular user. For example, virtual profile generation module 422 may generate, based on preference identification algorithm 412a, predicted preference information for user 402b.

At 508, method 500 includes storing virtual preference information in the dataset, where the virtual preference information is based on the predicted preference information. For example, the virtual preference information may be stored in dataset 104.

At 510, method 500 includes identifying a plurality of users from the users of the dataset, where the plurality of users are a subset of the dataset, and where the particular algorithm has been identified as a predicted preference identification algorithm for the plurality of users. For example, preference information 408a, 408c, and 408n may correspond to preference identification algorithm 412a and may be identified. Additionally, the virtual preference information may be identified.

At 512, method 500 includes generating a graph that indicates similarity values between preference information of the plurality of users, where the graph includes the virtual preference information. For example, weighted graph 300 of FIG. 3 may be generated.

At 514, method 500 includes determining a recommended association for the particular user, including identifying similar users to the particular user from the plurality of users and selecting a recommended association based on associations of the similar users. For example, a recommended association may be generated based on weighted graph 300 and associations of the corresponding users.

At 516, method 500 includes sending the recommended association to the particular user. For example, the recommended association may be included in association response 436.

At 518, method 500 includes removing the virtual preference information from the dataset. For example, the virtual preference information may be removed from dataset 104.

At 520, method 500 includes receiving feedback regarding the recommended association. For example, interaction indicator 438 may be received.

At 522, method 500 includes, in response to the feedback indicating a second algorithm from the plurality of algorithms, selecting the second algorithm as the predicted preference identification algorithm for the particular user. For example, in response to interaction indicator indicating preference identification algorithm 412c (e.g., by indicating that the recommended association was not accepted), preference identification algorithm 412c may be selected as the preference identification algorithm for user 402b. Accordingly, a method of generating a recommended association is depicted.

Referring now to FIG. 5B, a flow diagram of a second method 525 of generating a recommended association is depicted. In some embodiments, method 525 may be initiated or performed by one or more processors in response to one or more instructions stored by a computer-readable storage medium. In various embodiments, some portions of method 525 may be performed in other orders. For example, in some embodiments, 532 may be performed before 530.

At 530, method 525 includes storing a dataset including preference information indication associations between items indicated by the dataset and users of a computer system. For example, computer server system 102 of FIG. 4 may store preference information 408a-n and item indications 420.

At 532, method 525 includes receiving a request for a recommended association between a particular user and one or more of the items. For example, computer server system 102 of FIG. 4 may receive association request 434 from user 402b, requesting a recommended association between user 402b and one or more items indicated by item indication(s) 420.

At 534, method 525 includes identifying, based on preference information of the particular user, one or more characteristics of the one or more items, or both, a recommendation goal for the recommended association. For example, goal module 138 may determine, based on preference information 408b and one or more characteristics of the one or more items (e.g., the one or more items are all real estate listings), a recommendation goal (e.g., provide a real estate listing recommendation for the particular).

At 536, method 525 includes selecting, based on the preference information of the particular user and the recommendation goal, a particular algorithm of a plurality of algorithms as a predicted preference identification algorithm for the particular user. For example, preference identification selection module 106 may select preference identification algorithm 412a for user 402b.

At 538, method 525 includes determining, based on the predicted preference identification algorithm, a recommended association for the particular user. For example, a recommended association may be generated based on preference identification algorithm 412a

At 540, method 525 includes sending the recommended association to the particular user. For example, the recommended association may be included in association response 436.

At 542, method 525 includes receiving feedback regarding the recommended association. For example, interaction indicator 438 may be received.

At 544, method 525 includes, in response to the feedback indicating a second algorithm from the plurality of algorithms, selecting the second algorithm as the predicted preference identification algorithm for the particular user. For example, in response to interaction indicator indicating preference identification algorithm 412c (e.g., by indicating that the recommended association was not accepted), preference identification algorithm 412c may be selected as the preference identification algorithm for user 402b. Accordingly, a method of generating a recommended association is depicted.

Turning next to FIG. 6, a block diagram illustrating an exemplary embodiment of a computing system 600 that includes at least a portion of a reinforcement learning for recommended associations. In some embodiments, computing system 600 includes or corresponds to some or all of computer server system 102 of FIG. 1A, computer server system 102 of FIG. 1B, the computer server system of FIG. 4, or any combination thereof, including any variations or modifications described previously with reference to FIGS. 1A-5B. In some embodiments, some or all elements of the computing system 600 may be included within a system on a chip (SoC). In some embodiments, computing system 600 is included in a mobile device. In the illustrated embodiment, the computing system 600 includes fabric 610, compute complex 620, input/output (I/O) bridge 650, cache/memory controller 645, and display unit 665.

Fabric 610 may include various interconnects, buses, MUXes, controllers, etc., and may be configured to facilitate communication between various elements of computing system 600. In some embodiments, portions of fabric 610 are configured to implement various different communication protocols. In other embodiments, fabric 610 implements a single communication protocol and elements coupled to fabric 610 may convert from the single communication protocol to other communication protocols internally.

In the illustrated embodiment, compute complex 620 includes bus interface unit (BIU) 625, cache 630, and cores 635 and 640. In various embodiments, compute complex 620 includes various numbers of cores and/or caches. For example, compute complex 620 may include 1, 2, or 4 processor cores, or any other suitable number. In some embodiments, cores 635 and/or 640 include internal instruction and/or data caches. In some embodiments, a coherency unit (not shown) in fabric 610, cache 630, or elsewhere in computing system 600 is configured to maintain coherency between various caches of computing system 600. BIU 625 may be configured to manage communication between compute complex 620 and other elements of computing system 600. Processor cores such as cores 635 and 640 may be configured to execute instructions of a particular instruction set architecture (ISA), which may include operating system instructions and user application instructions.

Cache/memory controller 645 may be configured to manage transfer of data between fabric 610 and one or more caches and/or memories (e.g., non-transitory computer readable mediums). For example, cache/memory controller 645 may be coupled to an L3 cache, which may, in turn, be coupled to a system memory. In other embodiments, cache/memory controller 645 is directly coupled to a memory. In some embodiments, the cache/memory controller 645 includes one or more internal caches. In some embodiments, the cache/memory controller 645 may include or be coupled to one or more caches and/or memories that include instructions that, when executed by one or more processors (e.g., compute complex 620), cause the processor, processors, or cores to initiate or perform some or all of the processes described above with reference to FIGS. 1A-5B.

As used herein, the term “coupled to” may indicate one or more connections between elements, and a coupling may include intervening elements. For example, in FIG. 6, display unit 665 may be described as “coupled to” compute complex 620 through fabric 610. In contrast, in the illustrated embodiment of FIG. 6, display unit 665 is “directly coupled” to fabric 610 because there are no intervening elements.

Display unit 665 may be configured to read data from a frame buffer and provide a stream of pixel values for display. Display unit 665 may be configured as a display pipeline in some embodiments. Additionally, display unit 665 may be configured to blend multiple frames to produce an output frame. Further, display unit 665 may include one or more interfaces (e.g., MIPI® or embedded display port (eDP)) for coupling to a user display (e.g., a touchscreen or an external display).

I/O bridge 650 may include various elements configured to implement: universal serial bus (USB) communications, security, audio, and/or low-power always-on functionality, for example. I/O bridge 650 may also include interfaces such as pulse-width modulation (PWM), general-purpose input/output (GPIO), serial peripheral interface (SPI), and/or inter-integrated circuit (I2C), for example. Various types of peripherals and devices may be coupled to computing system 600 via I/O bridge 650.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

What is claimed is:

1. A method comprising:
storing, by a computer system, a dataset including preference information indicating associations between items indicated by the dataset and users of the computer system;
receiving, by the computer system, a request for a recommended association between a particular user and one or more of the items;
selecting, by the computer system based on preference information of the particular user, a particular algorithm of a plurality of algorithms as a predicted preference identification algorithm for the particular user;
generating, by the computer system based on the predicted preference identification algorithm, predicted preference information for the particular user;
storing, by the computer system, virtual preference information in the dataset, wherein the virtual preference information is based on the predicted preference information;
identifying, by the computer system, a plurality of users from the users of the dataset, wherein the plurality of users are a subset of the users of the dataset, and wherein the particular algorithm has been selected as a predicted preference identification algorithm for the plurality of users;
generating, by the computer system, a graph that indicates similarity values between preference information of the plurality of users, wherein the graph includes the virtual preference information;
determining, by the computer system, a recommended association for the particular user, comprising:
identifying similar users to the particular user from the plurality of users; and
selecting a recommended association based on associations of the similar users;
sending, by the computer system, the recommended association to the particular user;
removing, by the computer system, the virtual preference information from the dataset;
receiving, by the computer system, feedback regarding the recommended association; and
in response to the feedback indicating a second algorithm from the plurality of algorithms, selecting, by the computer system, the second algorithm as the predicted preference identification algorithm for the particular user.

2. The method of claim 1, wherein determining the recommended association further comprises generating a weighted list of recommended associations based on associations of the similar users, wherein selecting the recommended association comprises selecting the recommended association from the weighted list of recommended associations.

3. The method of claim 1, wherein identifying the similar users comprises comparing the preference information of the particular user to the preference information of at least some of the plurality of users.

4. The method of claim 3, further comprising adjusting, based on the feedback, an algorithm used to identify the similar users.

5. The method of claim 4, wherein adjusting the algorithm comprises selecting, from a plurality of user similarity identification algorithms, a different algorithm for users corresponding to the particular algorithm.

6. The method of claim 1, wherein the feedback comprises an indication of whether the particular user accessed an item indicated by the recommended association.

7. The method of claim 6, further comprising tracking item accesses by the particular user, wherein the feedback is generated based on tracking the item accesses.

8. The method of claim 1, wherein the feedback comprises a message from the particular user that indicates whether the particular user accepted the recommended association.

9. The method of claim 1, wherein the plurality of algorithms include at least a stochastic gradient descent algorithm and an alternating least squares algorithm.

10. A non-transitory computer-readable medium having program instructions stored thereon that, when executed by a computer server system, cause the computer server system to perform operations comprising:
storing a dataset including preference information indicating associations between items and users;
receiving a request for a recommended association between a particular user and one or more items of the dataset;
selecting, based on preference information of the particular user, a particular algorithm of a plurality of algorithms as a predicted preference identification algorithm for the particular user;
generating, based on the predicted preference identification algorithm, predicted preference information for the particular user;
storing virtual preference information in the dataset, wherein the virtual preference information is based on the predicted preference information;
generating a graph that indicates similarity values between a plurality of users of the dataset, wherein the graph includes the virtual preference information;
determining a recommended association for the particular user, comprising:
identifying similar users to the particular user from the plurality of users; and
selecting a recommended association based on associations of the similar users;
sending the recommended association to the particular user; and
removing the virtual preference information from the dataset.

11. The non-transitory computer-readable medium of claim 10, wherein the operations further comprise:
receiving, from the particular user, feedback regarding the recommended association; and
in response to the feedback indicating a second algorithm from the plurality of algorithms, selecting the second algorithm as the predicted preference identification algorithm for the particular user.

12. The non-transitory computer-readable medium of claim 10, wherein the operations further comprise identifying a subset of the users of the dataset as the plurality of users.

13. The non-transitory computer-readable medium of claim 12, wherein identifying the subset of the users comprises filtering the users of the dataset based on predicted preference identification algorithms associated with the users.

14. The non-transitory computer-readable medium of claim 12, wherein identifying the subset of the users comprises filtering the users of the dataset based on the one or more items of the dataset associated with respective users.

15. The non-transitory computer-readable medium of claim 12, wherein identifying the subset of the users comprises filtering the users of the dataset based on the preference information of the users.

16. A non-transitory computer-readable medium having program instructions stored thereon that, when executed by a computer server system, cause the computer server system to perform operations comprising:
storing a dataset including preference information indicating associations between items and users;
receiving a request for a recommended association between a particular user and one or more items of the dataset;
selecting, based on preference information of the particular user, a particular algorithm of a plurality of algorithms as a predicted preference identification algorithm for the particular user;
generating, based on the predicted preference identification algorithm, predicted preference information for the particular user;
storing virtual preference information in the dataset, wherein the virtual preference information is based on the predicted preference information;
generating a graph that indicates similarity values between a plurality of users of the dataset, wherein the graph includes the virtual preference information;
determining a recommended association for the particular user, comprising:
identifying similar users to the particular user from the plurality of users; and
selecting a recommended association based on associations of the similar users;
sending the recommended association to the particular user;
removing the virtual preference information from the dataset;
receiving feedback regarding the recommended association; and
in response to the feedback indicating a second algorithm from the plurality of algorithms, selecting the second algorithm as the predicted preference identification algorithm for the particular user.

17. The non-transitory computer-readable medium of claim 16, wherein the computer server system is configured to receive the feedback from a monitoring module configured to monitor whether the particular user interacts with an item indicated by the recommended association.

18. The non-transitory computer-readable medium of claim 17, wherein the monitoring module is further configured to monitor an amount of time the particular user interacts with the item indicated by the recommended association.

19. The non-transitory computer-readable medium of claim 16, wherein the operations further comprise modifying, based on the feedback, an algorithm used to identify the similar users.

20. The non-transitory computer-readable medium of claim 16, wherein the operations further comprise selecting the particular algorithm based on the preference information of the particular user indicating that the request is a first request for a recommended association from the particular user, wherein the particular algorithm is a default algorithm.
